(19) United States
(12) Patent Application Publication
(10) Pub. No.: US 2010/0303038 A1
(43) Pub. Date: Dec. 2, 2010

(54) Method for optimizing network structures in radio networks

(76) Inventors: Albert Krohn, Karlsruhe (DE); Sabin Wendhack, Karlsruhe (DE)

Correspondence Address: COLLARD & ROE, P.C., 1077 NORTHERN BOULEVARD, ROSLYN, NY, 11576, US

(21) Appl. No.: 12/798,282

(22) Filed: Apr. 1, 2010

(30) Foreign Application Priority Data
Apr. 2, 2009 (DE) 10 2009 003 724.1

(51) Int. Cl. H04W 4/00; G06F 11/00

(52) U.S. Cl. 370/330; 714/704; 714/E11.004

(57) ABSTRACT

In WirelessHART networks, mechanisms are already known that ensure a practical composition of a radio network with regard to its structure, whereby for this purpose, so-called health reports are also utilized, which are transmitted by the individual nodes to a central master. It is the task of the invention to improve the efficiency of such networks. Since no conclusions concerning the connection quality in the network can be drawn on the basis of data collected up to now that relate to the status of the node as such, additional parameters of the network that characterize the connection quality are collected within the scope of the invention. These are evaluated by the central master, which derives measures for optimizing the efficiency of the network from them and automatically implements them.

### CROSS REFERENCE TO RELATED APPLICATIONS

Applicants claim priority under 35 U.S.C. §119 of German Application No. 10 2009 003 724.1 filed Apr. 2, 2009.

### BACKGROUND OF THE INVENTION

1. Field of the Invention

The present invention relates to a method for optimizing network structures in radio networks, in which a master assigns each connected slave node at least one time slot and at least one frequency channel for communication and calls up the slave node cyclically to send at least one data packet on the frequency channel assigned to it, within its time slot, which packet comprises a status data set with status data determined on the part of the slave node, regularly or in the case of an explicit prompt from the master.

2. The Prior Art

Such a method is already previously known from the U.S. Pat. No. 7,420,980 B1. The patent in question describes and claims a method that essentially corresponds to the known WirelessHART system, in which status data of the individual nodes of the radio network are taken into consideration to establish a communication order within a radio network.

The so-called WirelessHART protocol first of all provides a central master that uses a method for regulating communication, in which the master first sends a transmission prompt to the individual nodes and these then respond to it. The master therefore completely controls the communication sequences in the radio network, in each instance. The communication plan used for this consists of a superframe that runs through cyclically, within which a number of time slots is provided, whereby a plurality of frequency channels can also be selected for each of these time slots. In this manner, it is possible for multiple communication steps to take place within a time slot, in that these are distributed over different frequency channels.

Such a centrally controlled communication system has the disadvantage that the nodes, which act relatively non-autonomously, only have very restricted possibilities of having an effect on the communication sequences. For example, the individual nodes can automatically add themselves to the network, in that they listen for logon prompts of nodes already logged onto the system, react to them, and report to the master of the network in this manner, but the nodes have no kind of influence on the time slot or frequency channel assigned to them. In the case of impairments of the connection, in the worst case this will lead to the result that such a connection is lost. In the event that it can be maintained, however, a decreasing quality of the connection will lead to the result that frequent repetitions of the messages being sent will become necessary. However, this is specifically not desired. By assigning the transmission permission of each node to only one specific time slot, it is possible to do without transmission and reception readiness for the duration of the other time slots, in order to save energy. This allows particularly energy-efficient utilization of the nodes, in each instance. However, frequent repetitions of one and the same message are very inefficient for the node, since in this manner, energy is used needlessly. The useful lifetime without maintenance will therefore be clearly shorter in an unsuitable environment than under ideal conditions.

### SUMMARY OF THE INVENTION

It is therefore the task of the present invention to create a method in which the individual nodes can exert an influence on the quality of the connection between them and the master.

This task is accomplished by means of a method for optimizing network structures in radio networks, according to the characteristics of the main claim. Other practical embodiments of this method can be derived from the dependent claims.

Within the WirelessHART method, it is already known to transmit so-called health reports from the individual nodes to the master. Within these health reports, numerous parameters with regard to the function of the individual node are transmitted to the master, so that the latter can draw conclusions concerning the function of the node. However, since structural methods can only be derived from this in limited manner, which can particularly impair the connection quality within the radio network, the invention provides that additional status data be collected on the part of the nodes, to characterize the radio connection quality in the radio network, and that these be passed on to the master, so that the latter, as the central control unit for communication in the radio network, can react to them in suitable manner. The master, which receives the status data in question, will evaluate them and thereupon automatically initiate suitable measures for optimizing the efficiency of the radio network, within the scope of its possibilities. For this purpose, according to the invention, a number of rules and threshold values are preset in the master, which make a decision concerning individual measures quantifiable.

Because of this set of rules, the master is enabled, according to the present invention, to investigate and improve the general conditions for communication between the individual nodes. Energy consumption, reaction speed, and availability of the radio network are thereby improved.

It should be noted, in this regard, that in detail, the evaluation of the status data and the initiation of suitable measures, as well as the integration of the individual nodes into the superframe, i.e. the assignment of time slots and frequency channels for communication to the individual nodes, takes place by means of a so-called network manager. This is a software that usually runs in the area of the master, but can also run at a remote location from it. Within the scope of this application, for the sake of clarity, the term “master” refers both to the central communication node and to the network manager, which, however, can be separate from the central communication node in terms of software and/or physically.

In concrete terms, it is made possible for the master, within the scope of the invention, to block individual frequency channels for communication, at least within individual time slots, in the distribution of the communication times and frequency channels on the superframe. This can become necessary because checksum errors increasingly occur in the nodes on specific frequency channels, in other words it can be assumed that there is interference on the frequency channel, in each instance. In concrete terms, counting of the checksum errors in question, in the individual nodes, is carried out, whereupon the master will block a frequency channel if a corresponding error counter within the status data set of the nodes exceeds an error threshold value.

Within the framework of communication between any two nodes within the radio network, it is usually necessary for the transmitting node to return confirmation of the received data from the receiving node, in the reverse direction. For each packet sent, the transmitting node expects such a confirmation message, in each instance, within a predetermined time span. If it does not receive the confirmation message in question within this time span, then the transmitting node will assume that the transmitted data did not reach their recipient and will therefore send them again. The expected but not received confirmation messages are summed up in a separate counter, and if this exceeds its counter threshold value, blocking of the frequency channel in question will also be triggered.

Another reason for blocking the frequency channel is use of the channel by a different radio network. As soon as a node of the radio network therefore receives a message that comes from a node of an outside radio network or is directed at an outside node, then within the scope of the status data set, the node receiving the outside message will set a flag that indicates to the master that the frequency channel is busy. The master can react by blocking the frequency channel in response to such a set flag, as well, in order not to have to resolve superimposition of the communication of the two networks. In this connection, a distinction can be made, but does not have to be made, as to whether the outside network is another WirelessHART network or whether it is a network that uses a different protocol. In the first of these two cases, the node will receive the message without errors and will merely state that this message occurred in communication with an outside radio network; in the second of these cases, the node will determine an elevated energy level on the frequency channel in question and then set the flag if this energy level exceeds a corresponding energy level threshold. Such an elevated energy level permits the conclusion of communication of some kind on the channel in question, which should not be taking place within the scope of the node's own radio network, because of the subdivision within the superframe.

Usually, radio networks function not only in direct contact with the master, but also by passing a message on by way of multiple bridge nodes. In this manner, the trip from the master all the way to the actual slave node takes place, whereby within the scope of communication with a node that lies farther away, the bridge nodes pass the messages of the nodes that lie farther back on within their transmission window. If only one slave node that is connected with the master by way of a bridge node loses its connection with this bridge node or also newly enters into the network, the master will assign a new communication path to the node. For this purpose, the slave node waits for a logon prompt on the part of a node willing to make a connection, to which it responds when it is received and initiates the connection with the bridge node in this manner. As soon as a connection of a slave node with a bridge node is lost, the slave node can immediately attempt to automatically produce a connection with the network. However, as long as the master possesses data about alternate paths, it will assign a new communication path to the slave node, by way of other bridge nodes.

If errors occur that are not caused by outside communication or superimposition of messages and accompanying checksum errors, it can also be indicated, as an alternative measure, to select a different communication route. This is particularly the case if the so-called reception signal strength, referred to in abbreviated form as RSSI (Received Signal Strength Indication) goes below a value set for this purpose. If the reception signal strength becomes too weak during a communication connection, then this can possibly be corrected by re-planning the communication path. Therefore if a node shows such impairment, the master will release the node in question from its connections and plan a different communication path by way of which it will communicate with the slave node in question.

The master will also release a connection and re-plan it if this could mean that the time window would be exceeded, specifically if a system time difference between the bridge node and the slave node above a time threshold value provided for this purpose is found. Ideally, in this case a second possible bridge node should be present, by way of which the slave node can divert the data traffic and whose system time deviates less from the time of the slave node.

If, on the other hand, only the average deviation of the system time exceeds a threshold value, the master can alternatively provide, in this regard, that additional synchronization messages are exchanged between the two nodes in order to achieve better synchronization.

Another significant criterion within the network is the latency time, so that it is of interest to measure the latency time of a connection of the slave node to the master. When an established maximum latency time is exceeded, the master will again release the connection of the slave node and plan an alternative communication path, so that the slave node can communicate with the master by way of a different bridge node, without exceeding the threshold value of the latency time in this regard.

The radio nodes are usually autonomous, battery-operated nodes whose period of operation essentially depends on their energy consumption. Therefore, it is eminently important to keep the energy consumption within limits. Therefore a counting variable for the uninterrupted running time of the CPU of the node as well as of the transmission and/or reception devices, as the largest energy consumers within the node, must be provided within the status data set. As soon as the uninterrupted running time of these components exceeds a limit value, the master will plan more rest periods for the node in question, in order to ensure that greater energy savings can be achieved for the node in question, by means of less frequent repetitions of the regular queries. In particular, a greater burden on the CPU or the transmission and/or reception devices, respectively, can occur if large amounts of data have to be handled or frequent repetitions occur within the communication of the node in question.

In order to facilitate logon of new nodes or re-logon of nodes whose connection was released by the master, as many nodes as possible should regularly broadcast logon prompts, in order to give new nodes the possibility of logging on to them. In this regard, every newly logged on node will provide a variable in the status data set, in which it is entered how many logon prompts were received in connection with the node's own logon, and, if applicable, also how many logon nodes were available, on which logon could have taken place. If these numbers do not exceed a threshold value, in each instance, the master will plan in additional logon prompts from other slave nodes, in order to improve the logon situation within the network.

Also, the master can decide, on the basis of a counter for failed connection attempts and/or for repeated attempts to establish a connection, which is part of the status data set, whether the number of logon prompts currently being transmitted meets the requirements. If the counter for failed connection attempts and/or for repeated attempts to establish a connection exceeds a value provided for this purpose, the master will therefore plan additional logon prompts for the adjacent nodes, so that logon or re-logon to the network is facilitated.

### BRIEF DESCRIPTION OF THE DRAWINGS

The invention described above will be explained in greater detail in the following, using an exemplary embodiment.

The drawing shows:

FIG. 1 a schematically represented radio network having a master and nine nodes, as well as a superframe for coordination of the communication within the network,

FIG. 2 the radio network according to FIG. 1, with a possible starting configuration of the communication within the superframe,

FIG. 3 the radio network according to FIG. 2 after blocking of a frequency channel, i.e. a change to a different frequency channel, and

FIG. 4 the radio network according to FIG. 3 with other measures of the master.

### DETAILED DESCRIPTION OF PREFERRED EMBODIMENTS

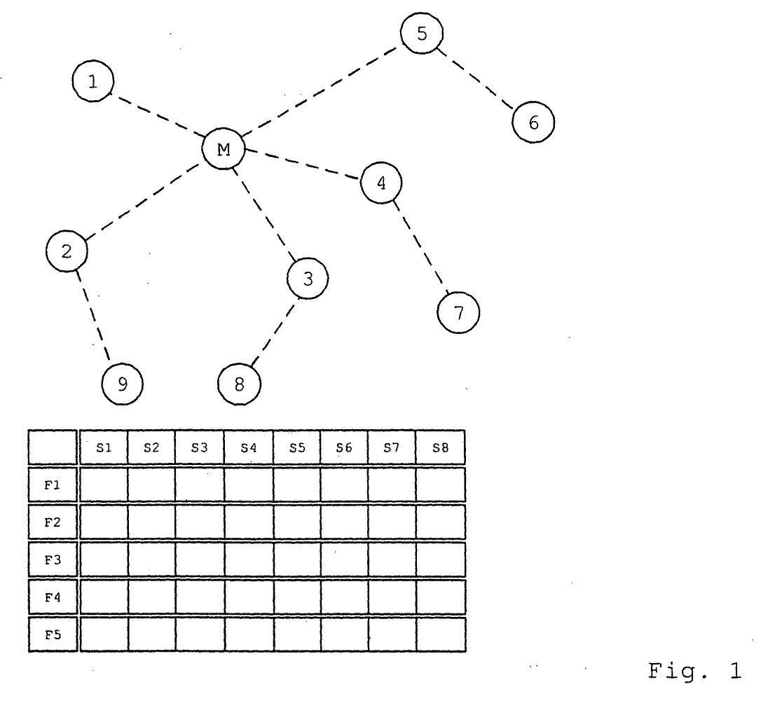

FIG. 1 shows a radio network consisting of a master M and a number of slave nodes 1-9, the latter of which are partly disposed as bridge nodes 2, 3, 4, 5, and partly as end-position nodes 1, 6, 7, 8, and 9. This differentiation relates only to the current position in the network. End-position nodes and bridge nodes are otherwise completely equivalent. The nodes 1 to 5 are directly connected with the master M. Also, FIG. 1 shows a superframe that demonstrates a number of time slots S1 to S8, which in turn are available on a number of frequency channels F1 to F5. Within the radio network, the master M will assign a time slot S1 to S8 and a frequency channel F1 to F5 to the slave nodes 1-9 for every communication step. Within this time slot S1 to S8, the slave nodes 1-9 can communicate with one another or with the master M, or can broadcast logon prompts A to log other nodes on to the network.

Within the scope of the communication that takes place between the nodes 1-9 and the master M, a status data set is transmitted to the master M, in each instance, from which the master M can derive a number of parameters relevant for the radio network from each node. On the basis of these parameters, the master M can influence the structure of the radio network and the assignment of the nodes to the superframe, in order to optimize the efficiency of the network.

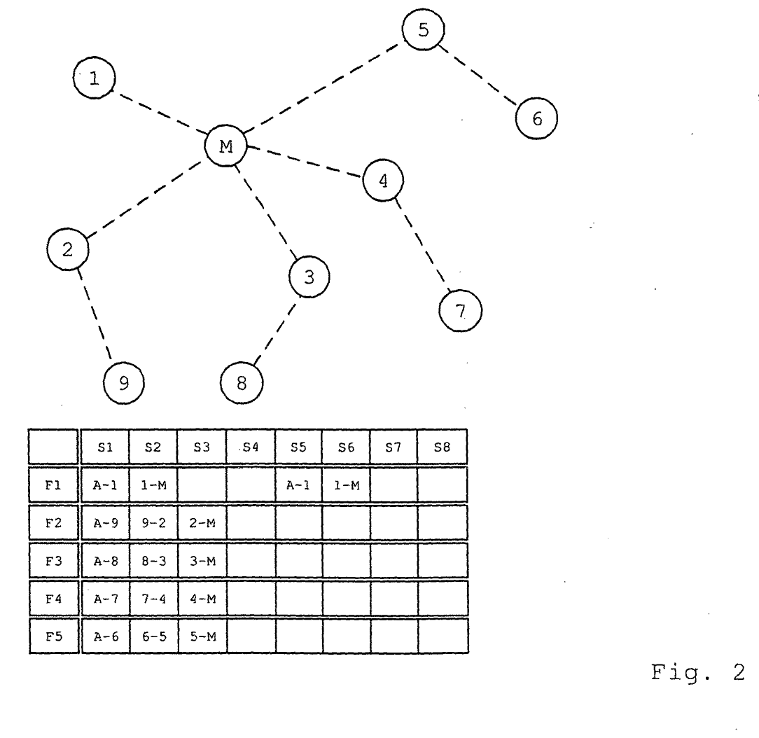

FIG. 2 shows the radio network with a superframe filled out as an example, in which logon prompts of individual nodes are provided within a time slot S1 to S8, in part, but also, communication paths for communication of the individual slave nodes 1-9 with the master are provided. In the present case, it is provided that the node 1 communicates with the master M within the frequency channel F1, within two time slots S2 and S6. In the time slots S1 and S5, the node 1 will broadcast logon prompts A, to which nodes willing to log on can respond. By means of such a response to a logon prompt A, the logon process into the radio network can be initiated.

Time slots S1 to S8 within the frequency channels F1 to F5 are also assigned to the other nodes 2-9, partly for communication and partly for transmitting logon prompts A.

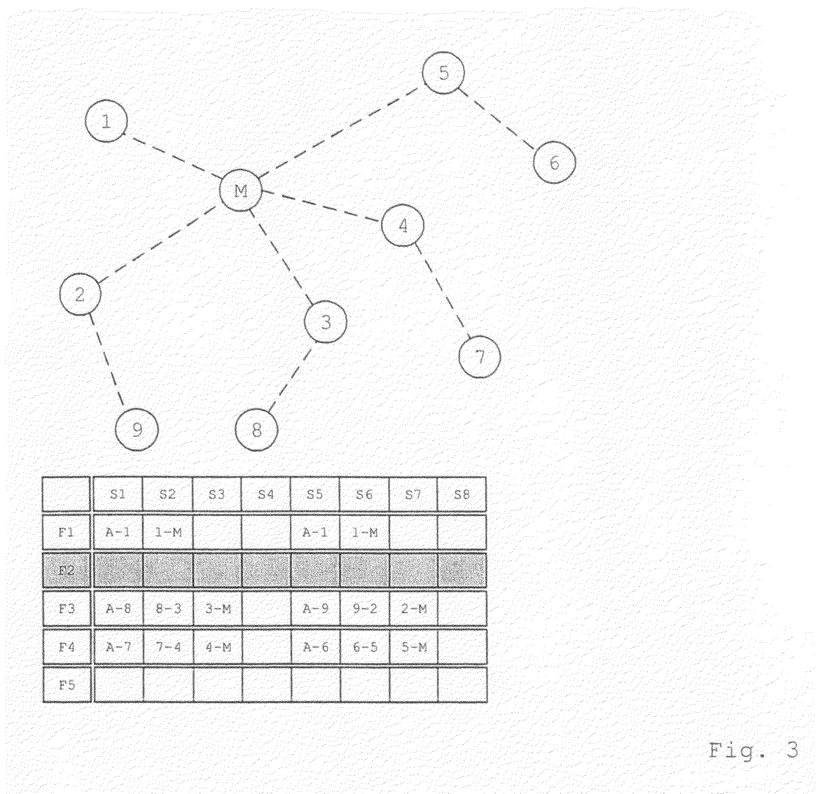

FIG. 3 shows the radio network and the superframe after the first measures by the master M. Here, a message has been received by the node 2, which comes from an outside WirelessHART network and therefore was also intended for an outside master. The slave node 2 deduces from this that the frequency channel F2 used by the node 2 is busy with the outside WirelessHART network and reports this to the master M within the framework of transmission of its status data. The latter then puts the frequency channel F2 on a blacklist for communication within the radio network, and thereby blocks access to the frequency channel F2 in question. For this purpose, it reassigns the communication events that were previously provided on the frequency channel F2 to other fields of the superframe, in concrete terms to the adjacent frequency channel F3. Because of the frequent absence of confirmation messages within the scope of communication of the bridge node 5 with adjacent nodes, all the communication that takes place with this bridge node 5 is also moved to a different frequency channel, namely, in concrete terms, to the frequency channel F4. By means of these measures, the master M prevents frequent repetitions on the frequency channel F2, which are to be feared due to the expected collision with messages from the outside network. Likewise, the master prevents a number of unnecessary repetitions on the frequency channel F5, which would have been expected due to the obviously poor reception in the node 5, since this node would have had to repeat its messages multiple times.

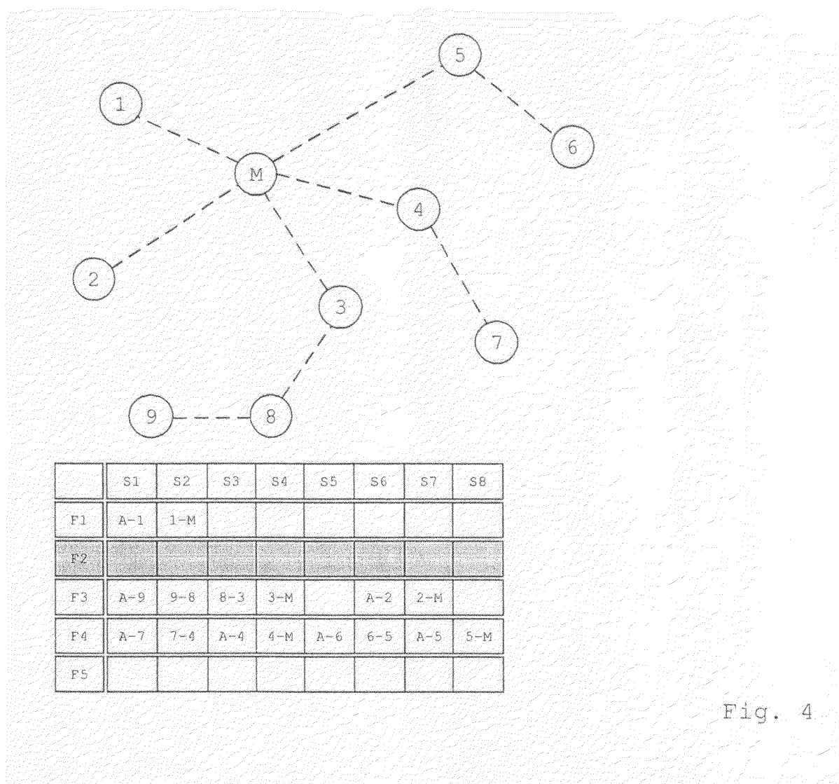

FIG. 4 shows additional measures by the master within the radio network, which are supposed to contribute to its optimization. For example, it was originally found that the node 9 could establish a connection with the logon node 2 only with difficulty. From this, the master M drew the conclusion that the connection between the slave node 9 and the logon node 2 could not be optimal, and releases the connection between the two slave nodes 2 and 9 and replaces the communication path with an alternative. For this purpose, the node 8, which is situated in the vicinity of the node 9, is suitable, so that the master M selects and plans this node as a new bridge node for the slave node 9. Node 9 therefore enters into a connection with the node 8 and is now connected with the master M by way of this node and the other bridge node 3. Since, at the same time, it becomes clear that only a few nodes are available for new connections on the radio network, the master M has commissioned additional nodes to transmit logon prompts, and has planned these into the corresponding time slots S1 to S8.

Therefore, a method for optimizing network structures in radio networks is described above, which makes it possible for the master of the network to take measures to improve the efficiency within the network, on the basis of data from the nodes that relate to the connection quality of the individual nodes among one another. This is implemented by means of transmitting a status data set containing parameters that characterize the network connection to the master, to which the master can react by taking suitable measures predetermined in fixed rules.

Although only a few embodiments of the present invention have been shown and described, it is to be understood that many changes and modifications may be made thereunto without departing from the spirit and scope of the invention.

1. Method for optimizing network structures in radio networks, in which a master (M) assigns each connected slave node (1-9) at least one time slot (S1-S8) and at least one frequency channel (F1-F5) for communication and calls up the slave node (1-9) cyclically to send at least one data packet on the frequency channel (F1-F5) assigned to it, within its time slot (S1-S8), which packet comprises a status data set with status data determined on the part of the slave node (1-9), regularly or in the case of an explicit prompt from the master (M), wherein the status data comprise parameters determined on the part of the slave node (1-9) for characterizing the radio connection quality, the master (M) evaluates the status data and thereupon automatically initiates measures for optimizing the efficiency of the radio network.

2. Method according to claim 1, wherein multiple frequency channels (F1-F5) are available to the master (M) within a time slot (S1-S8), at the same time, whereby the master (M) can block a frequency channel (F1-F5) for communication at least within a time slot (S1-S8).

3. Method according to claim 2, wherein an error counter for checksum errors that occur on a frequency channel (F1-F5) is contained within the status data set, whereby the master (M) blocks a frequency channel (F1-F5) as soon as the error counter for this frequency channel (F1-F5) exceeds an error threshold value.

4. Method according to claim 2, wherein two nodes (1-9, M) communicating with one another within the radio network acknowledge receipt of a data packet with a confirmation message, whereby the status data set comprises a counter for confirmation messages that are expected but were not received, and the master (M) blocks a frequency channel (F1-F5) as soon as the counter for this frequency channel (F1-F5) exceeds a counter threshold value.

5. Method according to claim 2, wherein a flag is set by the slave node (1-9), within the status data set, if use of the frequency channel (F1-F5) by an outside radio network is found, and the master (M) then blocks this frequency channel (F1-F5).

6. Method according to claim 5, wherein the flag for a frequency channel (F1-F5) is set when the energy level on this frequency channel (F1-F5) found in the slave node (1-9) exceeds an energy threshold value.

7. Method according to claim 5, wherein the flag for a frequency channel (F1-F5) is set when at least one data packet is received that comes from an outside radio network or is intended for an outside radio network.

8. Method according to claim 1, wherein communication between the master (M) and a slave node (1-9) takes place with the interposition of at least one bridge node (2, 3, 4, 5), whereby the master can release the connection of a slave node (1-9) with a bridge node (2, 3, 4, 5) and preferably plan a new communication path subsequently.

9. Method according to claim 1, wherein a slave node (1-9) listens for logon prompts (A) transmitted by possible logon nodes (1-9, M) in the event of a new start or loss of a connection with a bridge node (2, 3, 4, 5), and responds to the logon prompt (A) of a logon node that is located within reach, in order to make a connection with it, or is planned into a different communication path by the master (M).

10. Method according to claim 9, wherein the status data set comprises a counter for failed connection attempts and/or a counter for repeated attempts to establish a connection, whereby the master (M) releases the connection of the slave node (1-9) with its predecessor node (2, 3, 4, 5, M) and, if necessary, plans a new communication path to the slave node (1-9) if one of these counters exceeds a threshold value.

11. Method according to claim 9, wherein communication between the master (M) and a slave node (1-9) takes place by way of a path that comprises at least one bridge node (2, 3, 4, 5), whereby the status data set comprises an RSSI (Received Signal Strength Indication, indicator for the reception signal strength) for communication with the next node (1-9, M) that follows on the path, and the master (M) releases the connection of the slave node (1-9) with its predecessor node (2, 3, 4, 5, M) and, if necessary, plans a new communication path to the slave node (1-9) if the RSSI of at least one node (1-9, M) on the path goes below an RSSI threshold value.

12. Method according to claim 1, wherein the status data set comprises a maximal time difference between the system times in the slave node (1-9) and the bridge nodes (2, 3, 4, 5) that precede it on the path to the master (M), whereby the master (M) releases the connection of the slave node (1-9) in question if the maximal time difference exceeds a time threshold value, and preferably, another logon node (2, 3, 4, 5, M) is available, at the same time, from the system time of which the system time of the slave node (1-9) deviates less.

13. Method according to claim 1, wherein the status data set comprises an average time difference between the system times in the slave node (1-9) and the bridge nodes (2, 3, 4, 5) that precede it on the communication path to the master (M), whereby the master (M) orders the slave node (1-9) and the bridge node (2, 3, 4, 5) that precedes it on the path to exchange additional synchronization messages with one another.

14. Method according to claim 1, wherein the status data set comprises a maximal or average latency time of a connection between master (M) and slave node (1-9), whereby the master (M) releases the connection of the slave node (1-9) if a latency threshold value is exceeded by the maximal or the average latency time, and, if necessary, plans a new communication path to the slave node (1-9), by way of other bridge nodes.

15. Method according to claim 1, wherein the status data set comprises an uninterrupted running time of the CPU, of a transmission device and/or a reception device, whereby the master (M) reduces the frequency of the call-ups of the slave node (1-9) in question if this uninterrupted running time exceeds a running time threshold value.

16. Method according to claim 1, wherein the status data set comprises a counter for the number of logon nodes ready to enter into a connection and/or for the number of logon prompts (A) received, whereby the master (M) instructs additional nodes (1-9) to transmit additional logon prompts (A) if these counters do not exceed a threshold value.

17. Method according to claim 1, wherein the radio network is a WirelessHART network.
